(19) United States
(12) Patent Application Publication
(10) Pub. No.: US 2024/0384367 A1
(43) Pub. Date: Nov. 21, 2024

(54) NON-TOXIC AND ENVIRONMENTALLY FRIENDLY METHOD OF RECYCLING ACID MINE DRAINAGE (AMD) SLUDGE, LATERITE, AND SOIL TO SELECTIVELY EXTRACT RARE EARTH AND CRITICAL MINERALS

(71) Applicants: YEHUDIS GOTTESFELD, CANONSBURG, PA (US); YECHEZKEL MOSKOWITZ, CANONSBURG, PA (US)

(72) Inventors: YEHUDIS GOTTESFELD, CANONSBURG, PA (US); YECHEZKEL MOSKOWITZ, CANONSBURG, PA (US)

(73) Assignee: Materia USA LLC, Canonsburg, PA (US)

(21) Appl. No.: 18/197,237

(22) Filed: May 15, 2023

(51) Int. Cl. C22B 3/04; C02F 1/52; C22B 3/06; C22B 3/22; C22B 3/44; C22B 59/00

(52) U.S. Cl. CPC C22B 3/045; C02F 1/5236; C22B 3/06; C22B 3/22; C22B 3/44; C22B 59/00; C02F 2103/10

(57) ABSTRACT

A method to recycling acid mine drainage (AMD) sludge, laterite, or soil to selectively extract rare earth and critical minerals uses a leaching process to selectively dissolves metals from solids, through a series of operating conditions, via redox potential control to separate out rare earth elements (REE) and critical minerals from the AMD sludge, laterite, or soil.

### TECHNICAL FIELD

The present application generally relates to acid mine drainage (AMD) and, more particularly, to an environmental-friendly method of recycling acid mine drainage sludge, laterite, and soil to selectively extract rare earth and critical minerals.

### BACKGROUND

Acid mine drainage (AMD) may refer to acidic water that may form when surface water, which can mean rainwater, snowmelt, pond water, etc., and air is exposed to iron sulfide. AMD may commonly be formed as a byproduct of certain types of mining. More specifically, AMD water may be created from the dissolution of soluble metal compounds from ore, waste rock, and tailings during mining. The metals, exposed to toxic conditions, dissolve in the waters, thereby polluting the waters in the area. The resulting waters have a low pH, high electrical conductivity, and high metal content. In general, a water sample that reads below a pH of 7 is generally considered “acidic,” and the more acidic the water, the quicker it may erode rocks and other materials.

AMD waters are generally highly acidic and may be processed for their pH neutralization and subsequent water recirculation and reuse. The pH neutralization process may involve the precipitation of metals from the AMD waters to form a sludge, which may be called “AMD sludge”. The composition of AMD sludges varies and is generally primarily composed of Fe, Al, or Zn metals. The composition of the non-primary metals of AMD sludges varies as well, and can include Al, Zn, Fe, Si, Li, Mn, Zn, Ni, Cu, Co, Ca, Na, Mg, Ba, As, Se, Cr, Cd, Pb, La, Ce, and other rare earth and critical metals as may be seen in the table shown in FIG. 1. The vast majority of metals in AMD sludge may not be in entirely stable phases and have the potential to leach out from the sludge and into solutions under various mild conditions.

AMD sludge may be produced from the passive or active treatment of AMD waters. In general, passive treatments may be more commonly used. Passive AMD sludge treatment may expose AMD waters to chemicals, commonly lime or CaO and compost, for an extended period of time, to neutralize the pH and precipitate metals from the AMD waters in a process called “lime neutralization” or “anoxic lime drainage”. The AMD waters may sit in a storage pond with a horizontal water flow and the waters may be filtered downward. At the bottom of the storage pond may be a layer of compost with a layer of limestone underneath it. The metals may be removed from the AMD waters through the compost and the limestone may neutralize the pH of the waters.

During the water treatment process, metals may be precipitated out from AMD waters at different rates. While each AMD water source may be different, each should be tested individually to fully understand its sludge formation. For example, in one study performed on AMD waters in Southwest Spain, it was shown that the Fe may precipitated out first while Al and S (with minor amounts of Ca, Cu, Fe, and Si) may follow and divalent metals, such as Zn, Ni, and Co, may precipitated out last, at the bottom of the material. At the top of the material, in the Fe precipitation zone, the pH is generally low and the Eh, the redox (oxidation-reduction) state of a solution and may be a measurement of electric potential, may be in an oxidizing environment (around 700 mV). At the bottom of the material, the pH may be generally higher (around 6-8) and the Eh may be in a reducing environment (around 154 to 277 mV). Subsequent to the cessation of Fe precipitation and upon the pH of the AMD waters reaching 5, Al (and S) precipitation may take place. Al precipitation may be complete at pH 6.03, where the precipitation of Zn, Co, and Ni may begin to occur. Fe may reportedly precipitate out of the solution as metastable Fe phases, and may transform into Fe hydrates, such as goethite and hydrated ferric oxides, with a weakly crystalline structure and a spherical “sea urchin” morphology, generally forming associations of spheres ranging from 1 to 10 μm in diameter. Al may reportedly precipitate coating limestone grains and wood shavings. Zn, Ni, and Co may reportedly leave the solution as aggregates of microspheres 1 to 2 μm in diameter with similar morphology to the Fe precipitates. Many metals may be found to be associated in the Fe hydrates structure

Laterite ores, such as limonite, may possess similar properties to AMD sludges. Laterite ores generally have been formed through the leaching and subsequent precipitation of metals from the heavy weathering of soils and rocks (commonly occurring due to tropical rainfall). Laterite may often be found to be Fe-rich, and in some cases Al-rich. The Fe mineral in laterite reportedly contains most of the laterite's Ni and has a low crystallinity and highly defective (disordered) structure. The high disorder of the Fe structure may cause a charge imbalance in the mineral which must be compensated for and can result in its non-stoichiometric incorporation of “foreign” elements. The low crystallinity of the Fe structure may also facilitate the non-stoichiometric incorporation of foreign elements (such as Ni, Cr, and Al) into the Fe-bearing mineral lattice, reaching a partial equilibrium state between the phases in mutual contact. The low crystallinity of Fe-bearing minerals in laterite ores may reportedly be caused by the prevention of crystal growth from silica's presence in the migrating solution. The Fe-bearing mineral of laterite ores may also contain Mn, found as nano-granular (<15 nm) or acicular (50-100 nm/˜10 nm wide, L/W) crystals with low crystallinity within the Fe mineral structure. REEs were found in distinct mineral phases, such as cerianite and others, which had precipitated out.

Thus, AMD sludges, laterites, and some soils may contain valuable metals, such as rare earth and critical minerals. Due to the unique structures and compositions of the precipitated solids in AMD sludges, laterites, and some soils, these valuable metals may be extracted. Unfortunately, presently these valuable metals, such as rare earth and critical minerals cannot be extracted via environmentally neutral and cost-effective manners.

Therefore, it would be desirable to provide a system and method that overcomes the above. The system and method would allow valuable metals, such as rare earth and critical minerals to be extracted via environmentally neutral and cost-effective manner from AMD sludges, laterites, and some soils.

### SUMMARY

In accordance with one embodiment, a method to recycling acid mine drainage (AMD) sludge, laterite, or soil to selectively extract rare earth and critical minerals is disclosed. The method comprises: a leaching process to selectively dissolves metals from solids, through a series of operating conditions, via redox potential control to separate out rare earth elements (REE) and critical minerals from the AMD sludge, laterite, or soil; and a magnetic separation process to separate magnetic metals from non-magnetic minerals.

In accordance with one embodiment, a method to recycling acid mine drainage (AMD) sludge, laterite, or soil to selectively extract rare earth and critical minerals is disclosed. The method comprises a leaching process to selectively dissolves metals from solids, through a series of operating conditions, via redox potential control to separate out rare earth elements (REE) and critical minerals from the AMD sludge, laterite, or soil.

In accordance with one embodiment, a method to recycling acid mine drainage (AMD) sludge, laterite, or soil to selectively extract rare earth and critical minerals is disclosed. The method comprising: a leaching process to selectively dissolves metals from solids, through a series of operating conditions, via redox potential control to separate out rare earth elements (REE) and critical minerals from the AMD sludge, laterite, or soil, wherein the leaching step comprises multiple redox reaction processes, wherein each redox reaction process is controlled through a use of water and gaseous oxygen and or hydrogen to control Eh conditions to selectively remove a desired REE or critical mineral from gangue minerals; and a magnetic separation process to separate magnetic metals from non-magnetic minerals.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 is a table depicting an estimated concentration of metals in AMD sludge in accordance with an embodiment of the present invention;

FIG. 2 is a flowchart of an exemplary embodiment of a method for extracting valuable metals, such as rare earth and critical minerals from AMD sludges, laterites, and some soils in accordance with an embodiment of the present invention; and

FIG. 3 is a flowchart of an exemplary embodiment of a method for extracting valuable metals, such as rare earth and critical minerals from AMD sludges, laterites, and some soils in accordance with an embodiment of the present invention;

FIG. 4 is a chart depicting a Pourbaix Eh-pH stability diagram of Fe oxides in water at 25 deg C. and 1 bar in accordance with an embodiment of the present invention;

FIG. 5 is a chart depicting Pourbaix diagrams of Co, at 1 m, 25 deg C., and 1 bar in accordance with an embodiment of the present invention;

FIG. 6 is a chart depicting Pourbaix diagrams of Ni, at 1 m, 25 deg C., and 1 bar in accordance with an embodiment of the present invention;

FIG. 7 is a chart depicting Pourbaix diagrams of Mn, at 1 m, 25 deg C., and 1 bar in accordance with an embodiment of the present invention;

FIG. 8 is a chart depicting Pourbaix diagrams of Li, at 1 m, 25 deg C., and 1 bar in accordance with an embodiment of the present invention; and

FIG. 9 is a chart depicting magnetic susceptibility of different minerals in accordance with an embodiment of the present invention.

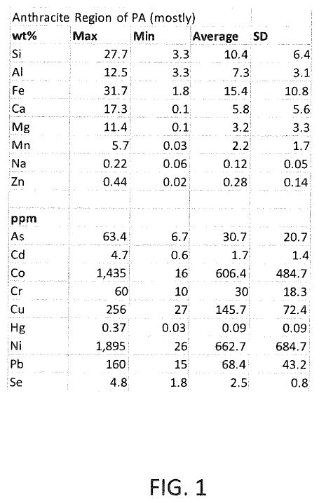

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary system and method disclose an environmentally friendly system and method to remove valuable metals from AMD sludge, laterites, and soils. The system and method may use a leaching process that selectively dissolves metals from solids, through a series of operating conditions, via redox potential control and magnetic separation to separate magnetic metals from non-magnetic minerals. The chemistry may be a derivative of the phase stability of metals, their oxidation-reduction reactions, and their magnetic susceptibilities. The system and method provide important environmental and cost improvements over existing methods for extracting metals.

The redox potential of a solution has significant implications on the mobility, phase, and persistence of many metals and minerals from their solids. Redox conditions determine whether constituents are released from rocks, sediments, and wastes into a solution, degrade into other chemicals, or not.

Redox potential separation may make use of the stability and solubility of metals and minerals within a material to separate out valuable metals, such as rare earth and critical minerals, through applying suitable Eh condition(s) to a solution. Metals and their subsequent phases in a solution at a set Eh condition may be predetermined and can result in favorable conditions for selective metal dissolution. Although studied in literature for the purposes of understanding the toxicity and environmental harm of said metal leaching, the intentional separation, and more specifically the selective separation, of metals from AMD sludges, laterites, and soils in environmentally neutral conditions through a set process involving set Eh conditions and/or magnetic separation has not currently been implemented.

While research of leaching and/or the selective separation of metals from AMD sludge, laterite, and soil is studied and utilized, all previous processes involve acid leaching, bioleaching, and/or high temperature leaching for the dissolution of metals into solution. Furthermore, studied methods of metal extraction involve the collective dissolution of metals into solution and not the intentional selective separation of metals with a solid and liquid phase within the separation process operations simultaneously.

The present system and method may be aimed at optimizing the selective separation of metals from solids through leaching and magnetic separation operating conditions and parameters. In the system and method disclosed, the primary unit operation (i.e., redox leaching) of the separation chemistry may be conducted between a liquid and solid medium. The chemistry may consist of redox reactions propagated through the use of water and gaseous oxygen/hydrogen to control Eh conditions. The minor components (i.e., the valuable metals) of the solids may be selectively removed from the gangue minerals through a multi-step process where each metal is removed based on its phase properties and behaviors, which allows for improved separation. The non-valuable components of the feed may remain in a solid form, separated from the valuable components which may obtain a liquid form. The redox leaching process may use a set electric potential to drive the dissolution of metals into a solution. The electric potential of the solution may be increased through oxygen contact, which causes dissolution of select metals, to separate out harder-to-separate metals (i.e., metals that aren't soluble under standard water contact conditions). Hydrogen gas may be used to decrease the solution's Eh as needed.

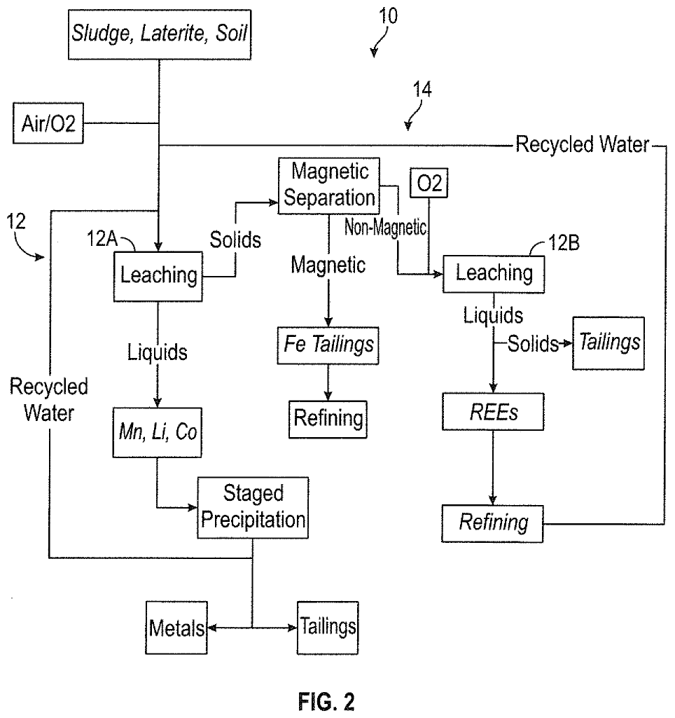

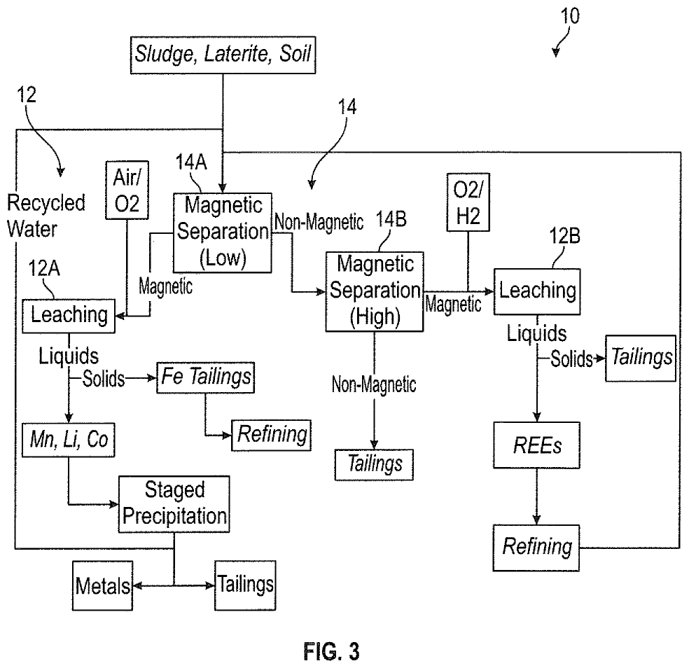

The system and method 10 shown in the figures may use a leaching process 12 and a magnetic separation process 14 to extract valuable metals, such as rare earth and critical minerals from AMD sludges, laterites, and some soils. The leaching process 12 may be performed in multiple steps. In the first leaching step 12A of the feed, the Fe-based minerals may release their non-Fe associated metals into the solution. The magnetic separation process 14 may then separate the distinct mineral phases within the solids, between those that are diamagnetic (gangue), paramagnetic (some REEs and critical minerals), and ferromagnetic (Fe-based minerals), based on the magnetic susceptibilities of the minerals. Due to the small particle size of the AMD sludge, distinct mineral phases may be liberated and no comminution is expected to be necessary for said feed. For feeds where REEs are within the Fe mineral's structure, leaching may be the first unit operation and the Eh increase implemented at the second leaching unit operation will leach the REEs into solution as may be seen in FIG. 2. Where REEs are in distinct mineral phases, apart from the Fe minerals, the magnetic separation process 14 may be the first unit operation as shown in FIG. 3. In this process, the magnetic separation process 14 may have a first magnetic separation 14A at a low magnetic field to separate the Fe-bearing minerals from the REEs. This may be followed by a second magnetic separation process 14B with a higher magnetic field to separate the magnetic REEs from the gangue minerals. Minerals and solids that do not dissolve into the solution and are not magnetic can be disposed of or sent to be treated further for external handling and/or processing.

As may be shown in FIG. 2, the system and method 10 may first use the leaching process 12 to separate the valuable metals from the gangue metals. As may be done in common leaching practices, all metals contained within the solids may be dissolved into a highly acidic solution. Once the metals are dissolved, the separation of each metal may begin to occur, by the addition of a base into the solution to raise the pH of the solution, as each metal is precipitated out individually. Acid leaching may not be the most efficient method to separate valuable from gangue minerals individually. In the process of acid leaching and precipitation, acids and bases are spent, the process is costly, the environment is exposed to hazardous chemicals, and the environmental impact of producing these chemicals puts a significant strain on the environment and public policy.

Thus, in the present embodiment of the method 10, metals may be leached into a solution naturally, under ambient and non-hazardous conditions. The leaching process 12 may have multiple steps. In a first step 12A of the leaching process 12, metals held within the Fe-based mineral structure are leached from the Fe structure and into the solution. In accordance with the present embodiment, the solution may be composed of water. In accordance with one embodiment, the water solution may maintain an Eh of around 0.250 V, a pH between 6 and 8, a temperature of 25° C., and a pressure of 1 bar. In natural ambient conditions, without mixing or the addition of oxygen or hydrogen gas, which may cause a redox potential change, the separation of metals from the Fe structure may occur but is not the most efficient process. To maintain selective separation while leaching the metals from the solids, an increase in surface area may be applied through vigorous mixing and/or bubble creation. Through the higher stability of Mn, Co, Li, and other metals for their ionic/liquid phases, and the higher stability for the Fe minerals to remain in the solid phase, under the set operating conditions, the minor constituent metals are released from the Fe-mineral structure as they take their ionic form and dissolve into the solution.

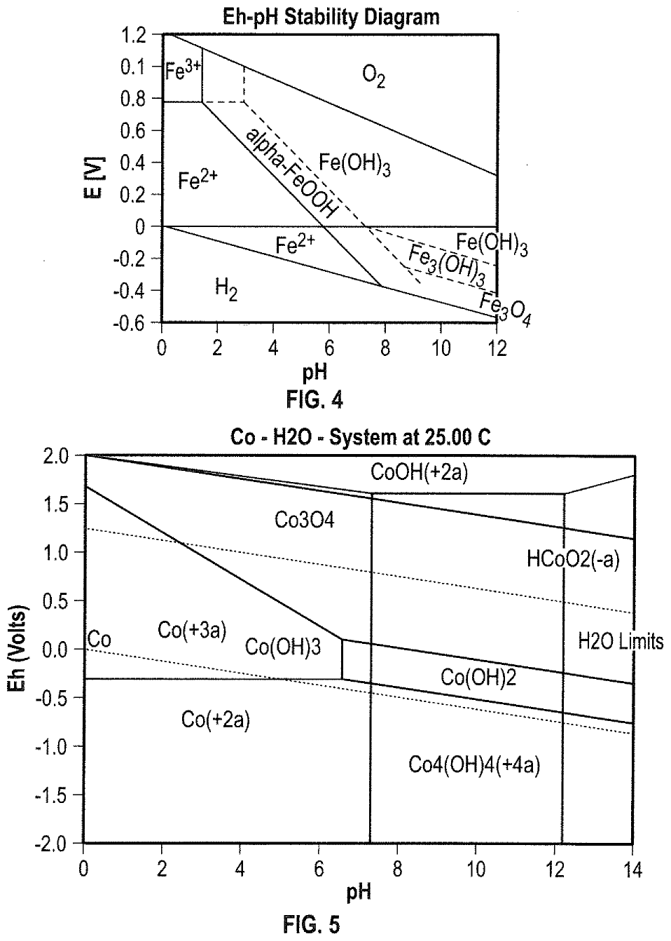

This unit operation works due to the stability of Fe phases, the extremely low solubility of the Fe mineral, and the initial structure of Fe with the value metal trapped in it in the feed. In the feed's solids, Fe is primarily in the goethite (α-FeOOH/FeOOH) and/or hydrated ferric oxide (Fe(OH)3)) form. Due to the Eh-pH condition's preference for the hydrated ferric oxides phase as may be seen in FIG. 4, and Fe(OH)3's insolubility in water, and the value metals' preference for its ionic form any metals attached to the goethite mineral form are released into the solution under set Eh and pH conditions (Eh 0.25 V and pH 6-8) and the Fe(OH)3 solid form is created in its more stable form. The more oxygen there is in the solution (i.e., the more oxygen the minerals are exposed to), the more the Fe(OH)3 phase will form. If metals are within the hydrated ferric oxide structure and not leaching into solution, a transformation via lowering the Eh of the solution to form goethite and then raising the solution to form the more stable Fe(OH)3 phase should be applied. As the Fe's solubility decreases with increasing potential (Eh), the forward reaction for the transition of goethite to Fe(OH)3 is favored, and the reaction equation is as follows:

FeOOH+H2O↔Fe(OH)3

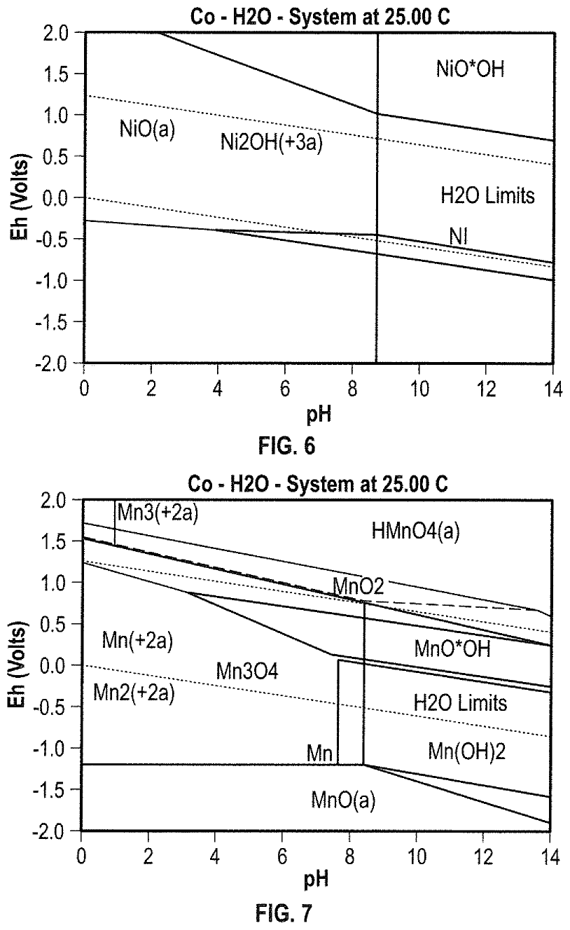

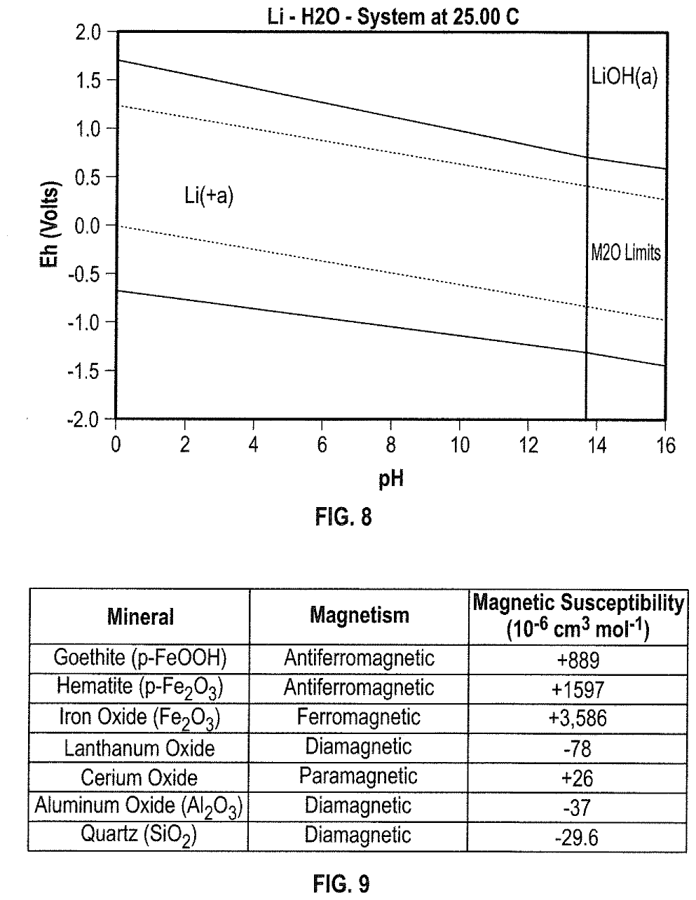

Taking a look at the metals incorporated into the Fe structure of the feed, Co, Ni, Mn, and Li are extremely soluble between the water line on the Eh-Ph diagram at Eh 0.25 V and pH 6-8 as may be seen in FIGS. 5-8.

In this step, the preferred separation method is to solubilize and oxidize the metals at or near ambient temperature and pressure, and at a slightly elevated Eh conditions and under neutral pH conditions to remove the valuable metals from their host mineral(s). Upon reaction with the oxygen/hydrogen in the set Eh conditions, the host mineral will release the value metals and stabilize, as the value metals prefer to move into the liquid (due to their stability at the set conditions) and the concentration of the value metals in solution will increase while the concentration of the gangue minerals decrease, offering efficient separation of the metals.

The method 10 may have a second leaching step 12B. In the second leeching step 12B, the solution may be sparged with oxygen to increase its Eh. As some value minerals are soluble at higher Eh values while Fe and other gangue minerals remain solids at said Eh values, increasing the Eh of the solution may further selectively leach the value metals into solution while keeping the Fe and other gangue minerals in the solid phase.

The AMD sludge generally has a small particle size with presumed sufficient mineral liberation, such that comminution is not expected to be required to increase its solubility (laterites and soils may have a greater particle size and therefore insufficient liberation, and so may need to undergo comminution prior to participating in this methodology. By increasing the contact surface area involved in leaching operations, the rate of the reaction may increase and release more value metals into solution. Air and/or oxygen (or hydrogen) mixing can be used to increase the contact surface area between the metals and solution, increasing the overall efficiency of the system, but may also increase the Eh of the solution. Therefore, an Eh increase and/or decrease is not desired, and non-reactive gases should be applied for mixing operations. It may be desired to have this unit operation be conducted in a mixed system with a controlled Eh and pH environment.

While the metals leached at Eh 0.250 V may be released from the Fe-bearing minerals, there may be metals that haven't yet been leached into the solution. Some of these metals may be valuable and belong to groups of REEs and other critical minerals, but they are not contained within the Fe-bearing minerals. Therefore, the remaining solids from the first leeching step 12A may be placed go through a multi-step magnetic separation process 14 to separate out these metals. In the embodiment shown in FIG. 2, multiple magnetic separators 14A, 14B may be used to separate out these metals.

The magnetic separators 14A, 14B may separate minerals/metals based on their magnetic susceptibilities. Magnetic susceptibility is a dimensionless parameter that indicates the degree of magnetization of a material in response to an applied magnetic field (i.e., how much a material would be attracted or repelled in an applied magnetic field). In numerical terms, it can be understood as the proportion between a material's magnetic moment and magnetic flux density. The magnetic susceptibility (i.e., magnetism) of a material may be caused by the motion of electrically charged particles in a material, by a material's electron interactions with an applied magnetic field. Electrons have spins, a quantum mechanical property, and charges which cause their magnetism. When the spins of electrons line up with the spin of a magnetic field, the material is magnetized (note: electrons with opposite spins have no net magnetic field since the positive and negative spins cancel each other out). The charge magnitude, particle velocity, and magnetic field strength within the system all may have an effect on the magnetic force on an electrically charged particle in the applied magnetic field. Therefore, the strength of the applied magnetic field can be altered to attract and repel or not interact with specific minerals.

Fe-based minerals are generally ferromagnetic (i.e., highly magnetic), many REE-based minerals and critical minerals are generally paramagnetic (i.e., magnetic), and gangue minerals are generally diamagnetic (i.e., non-magnetic) as may be seen in FIG. 9. Positive magnetic susceptibilities generally indicate a paramagnetic material (i.e., the induced magnetization strengthens the magnetic field of the material), and negative magnetic susceptibilities generally indicate a diamagnetic material (i.e., the induced magnetization weakens the magnetic field of the material). Ferromagnetic/antiferromagnetic materials generally have a high positive magnetic susceptibility and possess permanent magnetization without an applied magnetic field.

Therefore, by applying a weak magnetic field by the magnetic separator 14A to the solids not leached in the first leeching step 12A, the Fe-bearing minerals may be removed from the solids. Then, by applying a strong magnetic field by the magnetic separators 14B to the remaining solids which were not removed from the weak magnetic field, the paramagnetic minerals (i.e., some REEs and critical minerals) may be removed from the solids. The remaining material which was not magnetized and removed from the solids is the diamagnetic material, which is primarily quartz, aluminum oxide, and other gangue minerals.

The foregoing description is illustrative of particular embodiments of the application but is not meant to be a limitation upon the practice thereof. The following claims, including all equivalents thereof, are intended to define the scope of the application.

What is claimed is:

1. A method to recycling acid mine drainage (AMD) sludge, laterite, or soil to selectively extract rare earth and critical minerals comprising:
a leaching process to selectively dissolves metals from solids, through a series of operating conditions, via redox potential control to separate out rare earth elements (REE) and critical minerals from the AMD sludge, laterite, or soil; and
a magnetic separation process to separate magnetic metals from non-magnetic minerals.

2. The method of claim 1, wherein the leaching step comprises controlling redox reactions through a use of water and gaseous oxygen and or hydrogen to control Eh conditions to selectively remove the REEs and critical minerals from gangue minerals.

3. The method of claim 1, wherein the leaching step comprises multiple redox reaction processes, wherein each redox reaction process is controlled through a use of water and gaseous oxygen and or hydrogen to control Eh conditions to selectively remove a desired REE or critical mineral from gangue minerals.

4. The method of claim 1, wherein the leaching step comprises a redox reaction using a set electric potential to drive dissolution of a desired REE or critical mineral metal into a solution.

5. The method of claim 4, wherein the set electric potential of the solution is increased through oxygen contact causing dissolution of the desired REE or critical mineral metal into the solution.

6. The method of claim 5, wherein hydrogen gas is added to decrease an Eh of the solution to a desired level.

7. The method of claim 1, wherein the leaching process comprises leaching metals from an Fe-based mineral structure into a solution, wherein the solution is comprised of water.

8. The method of claim 1, wherein the leaching process comprises leaching metals from an Fe-based mineral structure into a solution, wherein the solution is comprised of water maintained at an Eh of 0.250 V, a pH between 6 and 8, a temperature of 25° C., and a pressure of 1 bar.

9. The method of claim 8, wherein the wherein the leaching process comprises increasing an Eh of the solution to selectively leach desired REEs and critical minerals from the solution while keeping Fe and other gangue minerals in a solid phase.

10. A method to recycling acid mine drainage (AMD) sludge, laterite, or soil to selectively extract rare earth and critical minerals comprising a leaching process to selectively dissolves metals from solids, through a series of operating conditions, via redox potential control to separate out rare earth elements (REE) and critical minerals from the AMD sludge, laterite, or soil.

11. The method of claim 10, wherein the leaching step comprises controlling redox reactions through a use of water and gaseous oxygen and or hydrogen to control Eh conditions to selectively remove the REEs and critical minerals from gangue minerals.

12. The method of claim 10, wherein the leaching step comprises multiple redox reaction processes, wherein each redox reaction process is controlled through a use of water and gaseous oxygen and or hydrogen to control Eh conditions to selectively remove a desired REE or critical mineral from gangue minerals.

13. The method of claim 1, wherein the leaching process comprises leaching metals from a Fe-based mineral structure into a solution, wherein the solution is comprised of water.

14. The method of claim 1, wherein the leaching process comprises leaching metals from an Fe-based mineral structure into a solution, wherein the solution is comprised of water maintained at an Eh of 0.250 V, a pH between 6 and 8, a temperature of 25° C., and a pressure of 1 bar.

15. The method of claim 14, wherein the wherein the leaching process comprises increasing an Eh of the solution to selectively leach desired REEs and critical minerals from the solution while keeping Fe and other gangue minerals in a solid phase.

16. The method of claim 10, comprising performing a magnetic separation process to separate magnetic metals from non-magnetic minerals.

17. The method of claim 10, comprising a magnetic separation process separating distinct mineral phases between those that are diamagnetic, paramagnetic, and ferromagnetic.

18. The method of claim 16, wherein magnetic separation process comprises performing a first magnetic separation process at a first magnetic field level and performing a second magnetic separation process at a second magnetic field level, wherein the second magnetic field level is at a higher level than the first magnetic field level.

19. A method to recycling acid mine drainage (AMD) sludge, laterite, or soil to selectively extract rare earth and critical minerals comprising:
a leaching process to selectively dissolves metals from solids, through a series of operating conditions, via redox potential control to separate out rare earth elements (REE) and critical minerals from the AMD sludge, laterite, or soil, wherein the leaching step comprises multiple redox reaction processes, wherein each redox reaction process is controlled through a use of water and gaseous oxygen and or hydrogen to control Eh conditions to selectively remove a desired REE or critical mineral from gangue minerals; and
a magnetic separation process to separate magnetic metals from non-magnetic minerals.

20. The method of claim 19, wherein the magnetic separation process comprises performing a first magnetic separation process at a first magnetic field level and performing a second magnetic separation process at a second magnetic field level, wherein the second magnetic field level is at a higher level than the first magnetic field level.
